(19) United States
(12) Patent Application Publication
(10) Pub. No.: US 2021/0141920 A1
(43) Pub. Date: May 13, 2021

(54) DYNAMIC VIEW FOR IMPLEMENTING DATA ACCESS CONTROL POLICIES

(71) Applicant: Okera, Inc., San Francisco, CA (US)

(72) Inventors: Amandeep Khurana, San Francisco, CA (US); Nong Li, San Francisco, CA (US)

(21) Appl. No.: 16/935,683

(22) Filed: Jul. 22, 2020

Related U.S. Application Data
(60) Provisional application No. 62/932,769, filed on Nov. 8, 2019.

(51) Int. Cl. G06F 21/62; G06F 21/31; G06F 16/22; G06F 16/16

(52) U.S. Cl. CPC G06F 21/6227; G06F 21/6254; G06F 2221/2141; G06F 16/221; G06F 16/168; G06F 21/31

(57) ABSTRACT

Various embodiments of the present technology generally relate to management of big data storage and data access control systems. In some embodiments, a data access system provides a user with an anonymized version of a dynamic view for a dataset. The system, in some implementations, supports data anonymization and filtering within a single view created for a dataset and eliminates the need to create separate views of a dataset for each access level. Embodiments herein include methods, apparatuses, and computer-readable media for enforcing access control policies within a multiple application and multiple storage system environment. In some implementations, a data access system receives a request to access a dataset from a user environment and subsequently identifies the user to a database. The database may respond to the request with controls for the user and the system may respond to the user environment with an anonymized representation of the dataset.

### CROSS-REFERENCE TO RELATED APPLICATIONS

This application is related to and claims priority to U.S. Provisional Patent Application No. 62/932,769, entitled “DYNAMIC VIEW FOR IMPLEMENTING DATA ACCESS CONTROL POLICIES,” filed on Nov. 8, 2019, which is incorporated by reference herein in its entirety.

### TECHNICAL FIELD

Various embodiments of the present technology generally relate to operation of data access systems for large data processing environments comprising multiple application services and multiple storage services. More specifically, some embodiments relate to a data access module for dynamic views, wherein the dynamic views support data anonymization and filtering of content in datasets according to user access-levels.

### BACKGROUND

The development of data-intensive applications to serve various needs, such as processing very large data sets, continues to grow as the possible number of applications grows too. Multiple storage services employed on clusters of computers are used to distribute various data. In addition to the multiple storage services, various large-scale processing applications have been developed to interact with the large-scale data sets and perform data management tasks, such as organizing and accessing the data and performing related operations with respect to the data.

To deploy the large-scale processing of data from multiple storage services in a computing environment, users are often required to individually configure programs to operate on a specific application service. These individually configured programs operating on each of the application services are typically not operable on a different application service or must be manually rebuilt by an administrator to adapt to the new application service environment. This rebuilding of each application service can be time consuming and cumbersome as each application service may have different deployment parameters. Each application service and storage service may require a determination of different data access and deployment requirements, such as determining authorization, performance, and caching parameters. Therefore, current techniques for enabling a user to operate the diverse application services available when accessing large-scale data sets from a variety of storage services are neither as efficient nor effective as they could be.

Data access systems provide a way to govern multiple storage systems and multiple application systems in a unified platform. Data access systems may require extensive access policies for enormous numbers of users and user types. Different users may have access to different views and data. The number of views for which to manage grants and revokes can make data access a tedious and error prone process. Having separate views that can be accessed by different users makes it difficult to provide transparent permissions controls to consumers of the data and the large number of objects required to implement separate views can be extremely burdensome.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for operating a data access system for large data processing environments comprising multiple application services and multiple storage services. In one implementation, a method for operating a data access system comprising multiple application services and multiple storage services provides for receiving a user request to access a dataset, wherein the user request is associated with an access level for the dataset. The method further provides for identifying at least one access control policy for the dataset based on the user request, disabling one or more elements of the dataset in a dynamic view of the dataset based on the at least one access control policy, and responding to the user request with the dynamic view, wherein the one or more elements are not displayed in the dynamic view.

In some embodiments, identifying the at least one access control policy comprises identifying a user associated with the user request and determining access controls for the user based the user and information stored in an access control database. The method may further comprise enabling one or more allowed elements of the dataset in the dynamic view based on the at least one access control policy. In some embodiments, disabling the one or more elements of the dataset in the dynamic view comprises anonymizing one or more columns of the dataset in the dynamic view based on the at least one access control policy, filtering one or more rows of the dataset in the dynamic view based on the at least one access control policy, or redacting one or more unallowed elements of the dataset in the dynamic view based on the at least one access control policy such that original content of the one or more unallowed elements cannot be identified in the dynamic view. In some embodiments, responding to the user request with the dynamic view comprises displaying the dynamic view in a user interface associated with the user request.

In another embodiment, a computing apparatus comprises one or more computer-readable storage media, a processing system operatively coupled with the one or more computer-readable storage media, and program instructions stored on the one or more computer-readable storage media to facilitate enforcing access control policies in data access environments that, when read and executed by the processing system, direct the processing system to at least receive a request to view a dataset, wherein the request is associated with an access level for the dataset. The processing system is further directed to identify at least one access control policy for the dataset based on the user request, disable one or more elements of the dataset in a dynamic view of the dataset based on the at least one access control policy, and respond to the user request with the dynamic view, wherein the one or more elements are not displayed in the dynamic view.

In yet another implementation, one or more computer-readable storage media has program instructions stored thereon to facilitate access control for data processing environments comprising multiple application services and multiple storage services. The program instructions, when read and executed by a processing system, direct the processing system to receive a user request to access a dataset, wherein the user request is associated with an access level for the dataset. The processing system is further directed to identify at least one access control policy for the dataset based on the user request, enable one or more elements of the dataset in a dynamic view of the dataset based on the at least one access control policy, and display the dynamic view in response to the user request, wherein the one or more elements are displayed in the dynamic view.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a data access system for use in a multiple application service and multiple storage service environment in accordance with some embodiments of the present technology;

FIG. 2 illustrates an example of an access environment in which a dynamic dataset view is displayed in multiple user environments according to different access levels in accordance with some embodiments of the present technology;

FIG. 3 illustrates a process for anonymizing a dynamic view of a dataset in accordance with some embodiments of the present technology;

FIG. 4 illustrates a sequence of interactions in a data access system for providing an anonymized view according to access controls stored in a database in accordance with some embodiments of the present technology;

FIG. 5 illustrates an example of anonymizing a base table in accordance with some embodiments of the present technology;

FIG. 6 illustrates an example of an anonymized dynamic dataset in accordance with some embodiments of the present technology;

FIG. 7 illustrates an example of a permissions table in accordance with some embodiments of the present technology; and

FIG. 8 illustrates a computing system for anonymizing dynamic views of datasets in a multiple application service and multiple storage service environment in accordance with some embodiments of the present technology.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

Heterogeneous, multi-vendor data platforms currently face many issues with opening data access for innovation while providing effective and efficient data security for various access levels. An active data access platform unifies and manages access for data consumers across multi-cloud, multi-datastore, and multi-tool environments. Tools such as Structured Query Language (SQL), Python, Spark, Map-Reduce, and R may apply machine learning and analytics to data. Infrastructures such as S3, Azure, Hadoop Distributed File System (HDFS), and on-premise databases serve as repositories for massive amounts of data. New compute and storage solutions are introduced constantly. The user of views for access control and associated difficulties in view management is well known in traditional relational database management systems (RDBMSs). Current approaches to servicing varying levels of access to users often requires setting up a different view of a given dataset for each access level. However, the need to create multiple views per dataset and keep them up to date make it difficult to implement future innovations, scale the platform, and much more. Column-level permissions attempt to solve these problems, but the approach is limited.

An effective data access platform enables a company to maintain accessibility, visibility, and security of data throughout the entire platform. However, when each solution has its own catalog, access controls, and auditing capabilities, data-driven organizations face issues achieving and maintaining these goals. In order to preserve agility, these organizations should be able to control fine-grained access to specific datasets, support a growing array of analytics tools, and capture detailed audit logs for usage insight and regulatory compliance.

A database administrator (DBA) directs or performs activities related to maintaining a successful database environment. A DBA may be responsible for designing, implementing, and maintaining the database system, establishing policies and procedures pertaining to management, security, maintenance, and use of the database management system, enrolling users, controlling user access, view maintenance, and much more. However, for large amounts of data, such as in a large-scale data access system, controlling access and view maintenance can be a burdensome job and too extensive for a DBA.

Current mechanisms for specifying access policies often rely on creating views to specify any required data transformations (e.g., tokenize a column, apply a filter, join with a white list, etc.) and then using grant or revoke powers to control access to the views. While this method may work and is capable of covering many cases of use, it requires creating many different views—leading to complexity for both data administrators in charge of granting access and end users having many catalog objects to deal with. For example, if a table has 10 columns with 10 different roles or access levels according to an access control list (ACL), where each of the 10 roles has access different columns, 10 separate views of the same table would need to be created (i.e., one for each role). The first view may have access to the first column, while the other nine columns are tokenized, the second view may have access to the first and second columns, while the other eight columns are tokenized, and so on. Similarly, ACLs may require that various groups have access to different rows in tables or that certain filters should be applied for some roles, further complicating which columns and rows can be accessed by which users.

Having many different views for which to manage grants and revokes can cause access management to be tedious and error prone. In some scenarios, end users need to know which views are suitable for them when submitting read requests. Columns-level permissions can provide some flexibility within views, but only for limited use cases and cannot be combined with other data transformations such as masking or row-level controls. Furthermore, having to know which view to reference eliminates the ability to make permission-control transparent to data consumers. By removing the need to create different views for each role, fewer objects are required, simplifying future tasks and actions (e.g., user interfaces (UIs), catalog search, auditing reporting, lineage, permission authoring, etc.).

Thus, embodiments herein include a data access module for dynamic views that support data anonymization and filtering without the need to create different views for each access level. The dynamic views feature simplifies and/or solves many issues for analyst users in a data access system. In some implementations, data is always read from the same catalog object, not a different view according to the user, and the need to maintain many views is eliminated. The present technology allows administrators to create a single view that can anonymize columns, filter out rows, and redact content down to the single-cell level while requiring minimal or no performance overhead.

The dynamic view engine described herein may, in some embodiments, be implemented within a built-in module (i.e., a builtin) or a similar module in a data access platform. The builtin, similar to other Structured Query Language (SQL) builtins to allow view definitions (or SQL queries), contains checks for access controls. The builtin, therefore, can be resolved entirely at planning time and require no runtime overhead. Each case may be consolidated into a single view capable of providing dynamic access to content. The builtin may be implemented within a data access platform to control which users have access to which content within the single view. The dynamic view may anonymize or filter data from specific, rows, columns, cells, or other regions of a data source.

In some examples, a DBA may issue grants on the base table for all end users, and all end users access the base table through the single view. However, the base table within the single view may exclude some data based on user permissions, access level, user type, and similar restrictions. In this manner, when a user attempts to access the base table, columns, rows, cells, and other information can be shown or anonymized (enabled or disabled) according to what the user is allowed to access.

FIG. 1 illustrates computing environment 100 for operating a data access system according to some embodiments. Computing environment 100 includes data access system 101, application services 110-112, and storage services 120-122. Data access system 101 is an example of a modular data access system described herein and includes catalog service 130 and data access service 140 that may execute on one or more physical computing systems. The one or more computing systems may include desktop computing systems, server computing systems, or any similar physical computing system capable of providing a platform for data access system 101. Data access service 140 includes views and tables 141 and files 142. Catalog service 130 includes audit engine 131, policy engine 132, and schema registry 133. Catalog service may also be implemented as a metadata service, in some examples, and may include fewer modules than shown in FIG. 1 or additional modules to the engines and registries shown in the present example.

Data access service 140 may apply schema, access policies, and other transformations including but not limited to Universal Disk Formats (UDFs), pseudonymization, and masking to data as well as perform input/output functions and provision data to various analytics tool. Data may be provisioned for a user in a useful, consumable manner. Views and tables 141 comprises structured data that may be presented to a user with a familiar abstraction of views and tables 141. Files 142 comprises unstructured data that is consumed in the form of file formats that may be requested by a user. Data access service 140 may include functionality for interacting with several types of retrieval, streaming, and analytics tools including but not limited to Spark, Python, SQL engines, Notebooks, and business intelligence (BI) tools such as Tableau, Microsoft Power BI, and Microsoft Excel.

Catalog service includes audit engine 131. In some examples, audit engine 131 provides a user with a detailed view of information related to their data. The information provided by audit engine may include but is not limited to user activity, popular datasets, and commonly used tools. Policy engine 132 provides functionality for defining and managing data access policies that can be applied as data is accessed without interrupting service. The policies in policy engine 132 may be defined and applied at several different granularities including database, dataset, rows, columns, and cells. In some embodiments, policy engine 132 includes role-based access control (RBAC) wherein permissions are based on roles, or personas, needing to perform specific, data-centric tasks. RBAC may be combined with Identity and Access Management (IAM) systems, such as Lightweight Directory Access Protocol (LDAP) based directories, to tie user groups into the role-based permissions, in an example. Policy engine 132 may implement data obfuscation for differential privacy wherein sensitive data may be dynamically protected using obfuscation functions including but not limited to anonymization, pseudonymization, redaction, and masking. Furthermore, policy engine 132 includes functionality for the implementation of dynamic views to meet access policy criteria as described herein.

Schema registry 133, in some examples, is an automated schema registry that automatically discovers, stores, and queries technical and operational metadata on datasets available to data consumers. Schema registry 133 is responsible for storing platform-wide dataset metadata, in some examples, wherein policy engine 132 controls access to those datasets. Schemas, dataset sizes, ownership, tags, annotations, and basic quality metrics may be some of the information contained within schema registry 133, in addition to other information. Users and applications may access schema registry 133 in addition to other information. Users and applications may access schema registry 133 via various application programming interfaces (APIs) and/or graphical user interfaces (GUIs). Schema registry 133, in some implementations, serves as a central schema registry shared across multiple analytics tools.

In operation, data access system 101 may perform access-based dynamic view processes for datasets, specifically scoped to eliminate the need to create a separate view for every access level. Data access system 101 receives a dataset access request from a user environment and retrieves access controls based on the user request from a dataset. Upon receiving access controls for the user, data access system 101 enables and/or disables components of the dataset within a dynamic view and provides the anonymized view to the user environment.

FIG. 2 illustrates an example of access environment 200 wherein a dynamic base table is displayed in two different user environments for separate users with different access levels. Access environment 200 includes data access service 201, data repository 202, user environment 205, user environment 206, data table 210, and data table 211. Data repository may be any data source accessed by data access service 201 capable of providing permissions information for the dynamic viewing functionality described herein. Data repository 202 may be a strictly permissions database, third-party database, customer profile database, transactional database, or any other repository of data.

User environment 205 can view data table 210 and user environment 206 can view data table 211. Data table 210 and 211 are derived from the same base table comprising columns A, B, C and rows 1, 2, 3. The base table is shown in a dynamic view capable of filtering out data from the base table according to the access requirements of each user environment. In some examples, the access level of a user environment may be determined based on the credentials of a user attempting to view the table through the user environment. Alternatively, the access level of a user environment may be based on a location, a computing environment, or any other factors that may affect what content may be viewed in the user environment.

Data from the base table may be anonymized, redacted, tokenized, filtered, pseudonymized, or hidden in a similar manner according to what a user environment is allowed to access. For example, in the example of FIG. 2, the base table may be shown without the columns or rows that cannot be accessed. As can be seen in data table 210, the only two rows of data, row 2 and row 3, are shown from the base table. Similarly, in data table 211, only two columns of the base table are shown, column A and column C. The base table may comprise columns A-C and rows 1-3, or may comprise additional columns and rows that are hidden in both user environment 205 and user environment 206. In some embodiments, rows, columns, or cells may be hidden in an alternative manner. For example, instead of removing a column or row, such as in data table 210 and data table 211, the hidden rows, columns, or cells may be shown but the data inside the cells may be disguised or hidden. The hidden data may be shown as empty cells, blurred cells, blank spaces, or any similar representation suitable for hiding or disguising data. The data may also be left out from representation entirely, such as row 1 in data table 210.

In the example of FIG. 2, data access service 201 receives a view request from user environment 205. Data access service 201 identifies the user to data repository 202. Data repository may then respond with access controls corresponding to the determined user access level. The user access level may be based on the user, the user environment, a user group, or variations or combinations thereof. Data access service 201 subsequently responds to user environment 205 with enablement instructions. Thus, the dynamic view of the base table can be opened in user environment 205 as data table 210, from which at least columns A, B, and C are shown, rows 2 and 3 are shown, and row 1 is omitted. The same process or a similar process may take place between user environment 206 and data access service 201 to obtain the dynamic view of the base table which can be opened as data table 211.

FIG. 3 is a flowchart illustrating process 300 in accordance with an embodiment of the present technology. In step 301, a request is received from a user to view a dataset from a database wherein the user is associated with an access level for one or more data elements included in the data. The request may be received in a data access system or similar environment. The request may be received by data access system 101, data access service 201, or any other data access platform similar to those described herein. In step 302, at least one access control policy for the dataset or one or more dataset elements is identified based on the user's associated access level. In some examples, the access level is based on information stored in a database, such an in the example of FIG. 2. An access level may be based on user-role, customer access status, payment tier, or any other factor restricting or enabling access to the data.

In step 303, one or more data elements of the data set are disabled in a dynamic view of the dataset based on the at least one access control policy for the dataset or the one or more elements. For example, if a user is authorized to access columns 1-3 and row 1 of a table but is not allowed to access columns 4-10 or rows 2-20, columns 4-10 and rows 2-20 would be disabled while columns 1-3 and row 1 would be enabled within the dynamic view by a data access system similar to those described herein. In the present example, the content from the dynamic table is displayed based on disablement (i.e., determining what a user cannot see and displaying everything else). However, in other examples, content from the dynamic table may be displayed based on enablement (i.e., determining what a user can see and displaying data accordingly). In similar examples, a combination of enablement and disablement may be utilized.

In step 304, the dynamic view of the dataset is displayed wherein the one or more disabled elements are hidden in the dynamic view. Enabled elements may be shown through a user environment similar to that described in reference to FIG. 2, in some examples. In the present example, data is excluded from the dynamic view using anonymization. Anonymization may be used to protect disabled data by tokenizing data, encrypting data, irreversibly altering data, or similar anonymization tactics. In alternative embodiments, data may be filtered, obfuscated, pseudonymized, redacted, masked, substituted, reversibly altered, hidden, blurred, removed, or disabled from viewing in a similar manner not included herein for purposes of brevity.

Using methods similar to those described in reference to FIG. 3, sensitive data may be dynamically protected such that differential privacy prevents individuals from being identified. A data access system, such as data access system 101, may include a data access control platform that allows data stewards, governance professionals, and the like to define and enforce fine-grained access control policies across multiple analytic compute engines and multiple storage systems. Access control may be achieved through RBAC based on an LDAP directory and authentication services such as Microsoft Active Directory, Kerberos, Okta, and similar, to manage access rights based on pre-defined groups. In some examples, access policies may be assigned based on identifiable user or data attributes. In this manner, policies may be linked to business or regulatory context to enrich data sets. Metadata tagging and policy enforcement may be automated, in some implementations, to assign policy at scale thus achieve automated data privacy.

FIG. 4 illustrates sequence 400 for providing a user with content from a dataset in a dynamic view. Sequence 400 includes an exemplary set of operations between user interface 410, native application 420, application service 430, and data repository 440. Application service 430 transfers a view to native application 420. Native application may be any program for use on a platform or device. Using the view, user interface 410 may initiate a request to access data through native application 420. Native application 420 transfers the request to application service 430. Application service 430 may be any application service capable of accessing and providing data from a data repository, including a data access system. Application service 430 may then transfer a user identification (ID) based on the request from the user interface to data repository 440.

Once data repository 440 has received the user ID, it may respond to application service 430 with access controls based on the user ID. Upon receiving the access controls, application service 430 can determine the enabled elements of the dataset view. The data view, in the present example, is a single dynamic view in which elements may be enabled or disabled according to permissions. Application service 430 may subsequently transfer the enabled elements to native application 420 and native application 420 can generate the anonymized view and display the anonymized view through user interface 410. The order of operations described in reference to FIG. 4 are not intended to be limited to a specific order, number of steps, number of components or programs, or a specific type of data. Furthermore, the sequence may include additional steps, fewer steps, different steps, or any variations or combinations thereof.

FIG. 5 illustrates an example of a dynamic view of a data table. Table 501 and table 502 may displayed in the same dynamic view. Table 501 is the raw table and, in the present example, may be shown in the view when all data elements are enabled or when a user has unrestricted access to the raw table. Alternatively, table 502 is an example of a dynamically altered version of table 501. Table 502 illustrates a few methods by which data can be filtered from table 501 according to access controls.

As discussed in reference to previous figures, hiding data according to access levels may occur in a variety of manners. For example, the data in column B of table 502 is blurred out to prevent a user from seeing the data within column B. In other examples, column B may be dynamically anonymized by leaving the column blank, removing the column, redacting the column, masking the column, pseudonymizing the column, and other similar methods. Similar to column B, rows 6 and 7 are blurred out in table 502.

Data may be filtered from the view in a variety of ways such as in the examples of columns F and G in table 502. Column F demonstrates an alternative approach in which a user may see that column F exists but cannot access the data values in the column. The data values in column F have are replaced with one or more filler characters per cell. The filler characters can be seen in rows 1 through 5 and row 8. Although two “X” characters are used to hide the elements in column F of table 502, many other characters including numbers, letters, symbols, or other fillings may be used to dynamically anonymize data from the view.

Column G illustrates an alternative example of hiding data in a column. Instead of completely hiding the values in rows 1-5 and 8 or column G, the numbers are represented as a range of values without providing the exact value. For example, row 1 column G of the full table, table 501, holds the value 53, but the filtered value in row 1 column G of table 502, the cell value is represented by “50+” to indicate that the value is over 50. The rest of the values in column G of table 502 are hidden in the same manner. This approach is solely provided as an example of the many different variations of data filtering that are anticipated herein. Dynamically filtering data from a view includes many different manners in which a user can be omitted from accessing data based on their access level.

The methods discussed for filtering data in rows and columns of table 502 may be used to filter any form of data in a base table such as table 501. For example, column B and rows 6 and 7 are blurred out from the user's view in the present example, but the method used to hide full rows or columns can also be used to dynamically filter single cells or blocks of data. Furthermore, instead of blurring cells containing data being hidden, cells, rows, and columns may be shaded, filled, left blank, or hidden in a similar manner. Similarly, the methods discussed in reference to filtering data in columns F and G in table 502 can be applied to any range of data including single cells or blocks of data.

FIG. 6 illustrates an example of a data table that is dynamically anonymized or filtered within dynamic view 600 according to embodiments of the present technology described herein. Table 601 includes data associated with transactions of active users and is titled “TRANSACTIONS_ACTIVE_USERS.” Table 601 includes columns labeled transaction number (txnid), last_active_time, address, stock keeping unit (sku), userid, price, and credit card. The view of table 601 in the example of FIG. 6 may be provided to a user through a user interface based on predetermined access controls for the user. Access controls for the user may be accessed or determined using similar methods to those described in reference to FIG. 2, FIG. 3, and FIG. 4.

Table 601 may be presented to a user in the dynamic view. The user of the present example has access to transaction data for all but two users in table 601. Furthermore, the user of the present example has access to txnid, last_active_time, address, sku, price, and credit card. However, the user of the present example does not have access to the userid of any transactions in the base table. The user also does not have access to the first twelve digits of the credit card number associated with each transaction. Although the user can see the title of the userid column, each of the cells is removed from the user's view by shading the column. The columns and rows that are dynamically left out from table 601 are all filtered from the table using shading. However, the credit card column provides an example of how data can be filtered in a different manner. Similarly, the address column of table 601 demonstrates an additional way in which data may be filtered in dynamic view 600 according to the access level of a user. In the present example, the address column only shows the state for each transaction and leaves out the rest of the address. The address data may be presented in this manner for all users or may only be presented in this manner for users of certain access levels.

Table 601 is derived from a base table and provided within the same view that would be provided for any user of any access level. Dynamic view 600 is a view in which data can be dynamically enabled or disabled according to a user's access settings. In some examples, dynamic view 600 anonymizes columns, filters out rows, and redacts data in individual cells based on what a user is allowed to access. Dynamic view 600 may enable all columns, rows, and cells for users with unrestricted access.

FIG. 7 illustrates an example of a permission table comprising data related to user permissions. FIG. 7 includes access table 701, wherein access table 701 includes columns labeled Data Request Rule, User, User Type, Dataset, Element, and Access Controls. Three data request rules are included in the Data Request Rule column. The data request rules of the present example include active_user, all_user, and admin. Each row of access table 701 is associated with a user, wherein the user's name is provided in the User column. In the present example, only three users are listed with their associated access controls. However, in many implementations, a permissions table like the one in FIG. 7 may include many more rows comprising permissions information for many more than three users as in the present example. A permissions table such as access table 701 may represent an access control database or may be stored in an access control database.

A dynamic view for a dataset, such as those provided in FIGS. 5 and 6, for example, may be displayed based on a permissions table such as access table 701. Access table 701 includes an Element column and an Access Controls column, which provide information on what data to enable or disable for a dataset based on user permissions. For example, for the user Sue, the column A and rows 1-5 should be hidden from the products dataset, as illustrated in access table 701. Based on the information provided in access table 701, the dynamic view for a given dataset provides the correct data to a specific user or user group.

As an additional example, if user Joe is attempting to access the inventory dataset and is subject to the all_user data request rule, the dynamic inventory view may display the inventory dataset for user Joe through a user interface. Within the dynamic view, user Joe may see the inventory dataset but with the restrictions outlined in the Element and Access Controls columns. Accordingly, the first digit would be hidden in column G, only the city would be displayed in row 3, column M would be hidden, and only the last 4 digits would be shown in row 5. As a final example, user Bob is subject to the admin data request rule. If Bob requests to access the transactions database, the transactions view would be shown wherein row 1 would show the user only, columns C-E would be hidden, and row 6 would show the year only.

In some embodiments, a permissions table may include an entirely different combination of rows and columns associated with access controls for various users, user groups, or similar. Certain embodiments of a permissions table may include information solely related to which data to exclude from dataset, while in other embodiments, a permissions table may include information solely related to which data to include in a dataset. In yet another embodiment, a permissions table may include information related to a combination of enabled and disabled data. Access table 701 is used for purposes of explanation and does not intend to limit what information may be stored in a permissions table comprising access control policies. In some examples, access table 701 may be stored in data repository 202 or data repository 440 from previous examples. However, access table 701 or similar access control data may be used in other implementations of dynamic views for data access systems.

A data access system such as data access system 101, data access service 201, and application service 430, may use an access table such as access table 701 to determine what elements to enable and/or disable in a dynamic view. A data access system may subsequently, in some examples, generate an anonymized view to display in a user environment. Data in an anonymized view may be filtered, anonymized, masked, redacted, or otherwise modified from an original table. User environment may be user environment 205, user environment 206, user interface 410 and native application 420, or a similar user environment in communication with a data access system.

FIG. 8 illustrates computing system 800 to perform access control for dynamic dataset views in a multiple application service and storage service environments according to one implementation. Computing system 800 is representative of any computing system or collection of systems with which the various operational architectures, processes, scenarios, and sequences disclosed herein for dynamic views in a data access system may be employed. Computing system 800 is an example of data access system 101 from FIG. 1, data access service 201 from FIG. 2, and application service 430 from FIG. 4, although other examples may exist. Computing system 800 may be implemented as a single apparatus, system, or device or may be implemented in a distributed manner as multiple apparatuses, systems, or devices.

Computing system 800 comprises communication interface 801, user interface 802, and processing system 803. Processing system 803 is linked to communication interface 801 and user interface 802. Processing system 803 includes processing circuitry 804 and memory device 805 that stores operating software 806. Computing system 800 may include other well-known components such as batteries and enclosures that are not shown in the present example for clarity. Examples of computing system 800 include, but are not limited to, desktop computers, laptop computers, server computers, routers, web servers, cloud computing platforms, and data center equipment, as well as any other type of physical or virtual server machines, physical or virtual routers, containers, and any variation or combination thereof.

Processing system 803 loads and executes software 806 from memory device 805. Software 806 includes and implements dynamic access control process 807, which is representative of the dynamic view generation processes discussed with respect to the preceding figures. When executed by processing system 803 to provide dynamic dataset views, software 806 directs processing system 803 to operate as described herein for at least the various processes, operational scenarios, and sequences discussed in the foregoing implementations. Computing system 800 may optionally include additional devices, features, or functionality not discussed for purposes of brevity.

Referring still to FIG. 8, processing system 803 may comprise a micro-processor and other circuitry that retrieves and executes software 806 from memory device 805. Processing system 803 may be implemented within a single processing device but may also be distributed across multiple processing devices or sub-systems that cooperate in executing program instructions. Examples of processing system 803 include general purpose central processing units, graphical processing units, application specific processors, and logic devices, as well as any other type of processing devices, combinations, or variations thereof.

User interface 802 comprises components that interact with a user to receive user inputs and to present media and/or information. User interface 802 may include a speaker, microphone, buttons, lights, display screen, touch screen, touch pad, scroll wheel, communication port, or some other user input/output apparatus, including combinations thereof. User interface 802 may be omitted in some examples.

Memory device 805 may comprise any computer-readable storage media readable by processing system 803 and capable of storing software 806. Memory device 805 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage media a propagated signal.

In addition to computer-readable storage media, in some implementations memory device 805 may also include computer-readable communication media over which at least some of software 806 may be communicated internally or externally. Memory device 805 may be implemented as a single storage device but may also be implemented across multiple storage devices or sub-systems co-located or distributed relative to each other. Memory device 805 may comprise additional elements, such as a controller, capable of communicating with processing system 803 or possibly other systems.

Software 806 (including dynamic access control process 807) may be implemented in program instructions and among other functions may, when executed by processing system 803, direct processing system 803 to operate as described with respect to the various operational scenarios, sequences, and processes illustrated herein. For example, software 806 may include program instructions for implementing a dynamic view process for data access systems as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 806 may include additional processes, programs, or components, such as operating system software, virtualization software, or other application software. Software 806 may also comprise firmware or some other form of machine-readable processing instructions executable by processing system 803.

In general, software 806 may, when loaded into processing system 803 and executed, transform a suitable apparatus, system, or device (of which computing system 800 is representative) overall from a general-purpose computing system into a special-purpose computing system customized to provide a multiple application service and storage service environment comprising access-based dynamic view processes as described herein. Indeed, encoding software 806 on memory device 805 may transform the physical structure of memory device 805. The specific transformation of the physical structure may depend on various factors in different implementations of this description. Examples of such factors may include, but are not limited to, the technology used to implement the storage media of memory device 805 and whether the computer-storage media are characterized as primary or secondary storage, as well as other factors.

For example, if the computer readable storage media are implemented as semiconductor-based memory, software 806 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface 801 may include communication connections and devices that allow for communication with other computing systems (not shown) over communication networks (not shown). Examples of connections and devices that together allow for inter-system communication may include network interface cards, ports, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. Communication interface 801 may be configured to use Time Division Multiplex (TDM), Internet Protocol (IP), Ethernet, optical networking, wireless protocols, communication signaling, or some other communication format, including combinations thereof. The aforementioned media, connections, and devices are well known and need not be discussed at length here.

Communication between computing system 800 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a data access system comprising multiple application services and multiple storage services, the method comprising:
receiving a user request to access a dataset, wherein the user request is associated with an access level for the dataset;
identifying at least one access control policy for the dataset based on the user request;
disabling one or more elements of the dataset in a dynamic view of the dataset based on the at least one access control policy; and
responding to the user request with the dynamic view, wherein the one or more elements are not displayed in the dynamic view.

2. The method of claim 1, wherein identifying the at least one access control policy comprises:
identifying a user associated with the user request; and
determining access controls for the user based on the user and information stored in an access control database.

3. The method of claim 1, further comprising enabling one or more allowed elements of the dataset in the dynamic view based on the at least one access control policy.

4. The method of claim 1, wherein disabling the one or more elements of the dataset in the dynamic view comprises anonymizing one or more columns of the dataset in the dynamic view based on the at least one access control policy.

5. The method of claim 1, wherein disabling the one or more elements of the dataset in the dynamic view comprises filtering one or more rows of the dataset in the dynamic view based on the at least one access control policy.

6. The method of claim 1, wherein disabling the one or more elements of the dataset in the dynamic view comprises redacting one or more unallowed elements of the dataset in the dynamic view based on the at least one access control policy such that original content of the one or more unallowed elements cannot be identified in the dynamic view.

7. The method of claim 1, wherein responding to the user request with the dynamic view comprises displaying the dynamic view in a user interface associated with the user request.

8. A computing apparatus comprising:
one or more computer-readable storage media;
a processing system operatively coupled with the one or more computer-readable storage media; and
program instructions stored on the one or more computer-readable storage media to facilitate enforcing access control policies in data access environments that, when read and executed by the processing system, direct the processing system to at least:
receive a user request to access a dataset, wherein the user request is associated with an access level for the dataset;
identify at least one access control policy for the dataset based on the user request;
disable one or more elements of the dataset in a dynamic view of the dataset based on the at least one access control policy; and
respond to the user request with the dynamic view, wherein the one or more elements are not displayed in the dynamic view.

9. The computing apparatus of claim 8, wherein identifying the at least one access control policy comprises:
identifying a user associated with the user request; and
determining access controls for the user based on the user and information stored in an access control database.

10. The computing apparatus of claim 8, wherein the program instructions further direct the processing system to enable one or more allowed elements of the dataset in the dynamic view based on the at least one access control policy.

11. The computing apparatus of claim 8, wherein disabling the one or more elements of the dataset in the dynamic view comprises further directing the processing system to anonymize one or more columns of the dataset in the dynamic view based on the at least one access control policy.

12. The computing apparatus of claim 8, wherein disabling the one or more elements of the dataset in the dynamic view comprises further directing the processing system to filter one or more rows of the dataset in the dynamic view based on the at least one access control policy.

13. The computing apparatus of claim 8, wherein disabling the one or more elements of the dataset in the dynamic view comprises further directing the processing system to redact one or more unallowed elements of the dataset in the dynamic view based on the at least one access control policy such that original content of the one or more unallowed elements cannot be identified in the dynamic view.

14. The computing apparatus of claim 8, wherein responding to the user request with the dynamic view comprises further directing the processing system to display the dynamic view in a user interface associated with the user request.

15. One or more computer-readable storage media having program instructions stored thereon to facilitate access control that, when read and executed by a processing system, direct the processing system to at least:
receive a user request to access a dataset, wherein the user request is associated with an access level for the dataset;
identify at least one access control policy for the dataset based on the user request;
enable one or more elements of the dataset in a dynamic view of the dataset based on the at least one access control policy; and
display the dynamic view in response to the user request, wherein the one or more elements are displayed in the dynamic view.

16. The one or more computer-readable storage media of claim 15, wherein identifying the at least one access control policy comprises directing the processing system to:
identify a user associated with the user request; and
determine access controls for the user based on the user and information stored in an access control database.

17. The one or more computer-readable storage media of claim 15, wherein the program instructions further direct the processing system to disable one or more unallowed elements of the dataset in the dynamic view based on the at least one access control policy.

18. The one or more computer-readable storage media of claim 17, wherein disabling the one or more unallowed elements of the dataset in the dynamic view comprises further directing the processing system to anonymize one or more columns of the dataset in the dynamic view based on the at least one access control policy.

19. The one or more computer-readable storage media of claim 17, wherein disabling the one or more unallowed elements of the dataset in the dynamic view comprises further directing the processing system to filter one or more rows of the dataset in the dynamic view based on the at least one access control policy.

20. The one or more computer-readable storage media of claim 17, wherein disabling the one or more unallowed elements of the dataset in the dynamic view comprises further directing the processing system to redact at least a portion of the one or more unallowed elements such that the original content of the one or more unallowed elements cannot be identified in the dynamic view.
